(19) United States
(12) Patent Application Publication
(10) Pub. No.: US 2018/0062492 A1
(43) Pub. Date: Mar. 1, 2018

(54) VIBRATION MOTOR

(71) Applicant: Nidec Seimitsu Corporation, Ueda-shi (JP)

(72) Inventors: Tomohiro AKANUMA, Ueda-shi (JP); Mitsuru OI, Ueda-shi (JP)

(21) Appl. No.: 15/657,342

(22) Filed: Jul. 24, 2017

(30) Foreign Application Priority Data
Aug. 30, 2016 (JP) 2016-168324

(51) Int. Cl. H02K 33/14; H02K 33/10; H02K 33/18; H02K 35/02

(52) U.S. Cl. CPC H02K 33/14; H02K 33/10; H02K 15/14; H02K 35/02; H02K 33/18

(57) ABSTRACT

A vibration motor includes a shaft having a center axis extending in one direction; a stationary portion having a coil wound in a circumferential direction of the center axis; a vibrating body arranged outside the shaft in a radial direction and being vibratable in the one direction relative to the stationary portion; and at least a single coil spring arranged between the stationary portion and the vibrating body, and wound in the circumferential direction. The vibrating body includes a weight and a magnet arranged inside the coil in the radial direction, in the one direction with respect to the weight. The coil spring overlaps the coil in the one direction.

### CROSS REFERENCE TO RELATED APPLICATIONS

This application claims the benefit of priority to Japanese Patent Application No. 2016-168324 filed on Aug. 30, 2016. The entire contents of this application are hereby incorporated herein by reference.

### 1. FIELD OF THE INVENTION

The present invention relates to a vibration motor.

### 2. DESCRIPTION OF THE RELATED ART

Various apparatuses of related art such as smartphones include vibration motors. Japanese Patent No. 5342516 discloses a vibration actuator of related art as follows.

The vibration actuator of Japanese Patent No. 5342516 includes a cylindrical casing. The casing houses a coil, a magnet, and first and second weights. The coil is wound in a ring shape around the vibration axis of the casing. The magnet is cylindrical and surrounded by the coil. The first and second weights are arranged adjacently to both sides of the magnet in a direction along the vibration axis. The magnet and the first and second weights form a rotor. A shaft penetrates through the rotor. Both ends of the shaft are fixed to end walls of the casing.

The first weight and the second weight have spring receiving holes. A first coil spring inserted into the spring receiving hole is arranged between the first weight and the end wall of the casing. Similarly, a second coil spring inserted into the spring receiving hole is arranged between the second weight and the end wall of the casing. A shaft penetrates through the first coil spring and the second coil spring.

With this configuration, the magnet and the first and second weights, serving as the rotor, linearly vibrate in the vibration axis direction by cooperation between the coil and the magnet.

However, in aforementioned Japanese Patent No. 5342516, the first and second coil springs have small coil diameters so that the first and second coil springs can be inserted into the spring receiving holes of the first and second weights. Hence, buckling may be likely generated at vibration of the rotor.

### SUMMARY OF THE INVENTION

A vibration motor according to an exemplary embodiment of the present application includes a shaft having a center axis extending in one direction; a stationary portion having a coil wound in a circumferential direction of the center axis; a vibrating body arranged outside the shaft in a radial direction and being vibratable in the one direction relative to the stationary portion; and at least a single coil spring arranged between the stationary portion and the vibrating body, and wound in the circumferential direction. The vibrating body includes a weight, and a magnet arranged inside the coil in the radial direction, in the one direction with respect to the weight. The coil spring overlaps the coil in the one direction.

With the exemplary embodiment of the present application, the vibration motor can suppress generation of buckling at the coil spring.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a general perspective view illustrating the external appearance of a vibration motor according to an embodiment of the present invention.

FIG. 2 is a side cross-sectional view taken along line II-II in FIG. 1.

FIG. 3 is an exploded perspective view relating to the configuration other than a movable portion in the vibration motor.

FIG. 4 is a perspective view illustrating the configuration of the movable portion in the vibration motor.

FIG. 5A is a perspective view illustrating a state in which respective members including a coil are fixed to a coil fixing portion.

FIG. 5B is a perspective view illustrating the state in which the respective members including the coil are fixed to the coil fixing portion (viewpoint different from FIG. 5A).

FIG. 6 is a side view illustrating the arrangement relationship of respective coil springs with respect to the movable portion in the exploded state.

FIG. 7 is a perspective view illustrating the configuration of a movable portion according to a modification.

FIG. 8 is a perspective view illustrating the external appearance of a vibration motor according to the modification.

### DETAILED DESCRIPTION OF THE PREFERRED EMBODIMENTS

An exemplarily embodiment of the present invention is described below with reference to the drawings.

### 1. General Configuration of Vibration Motor

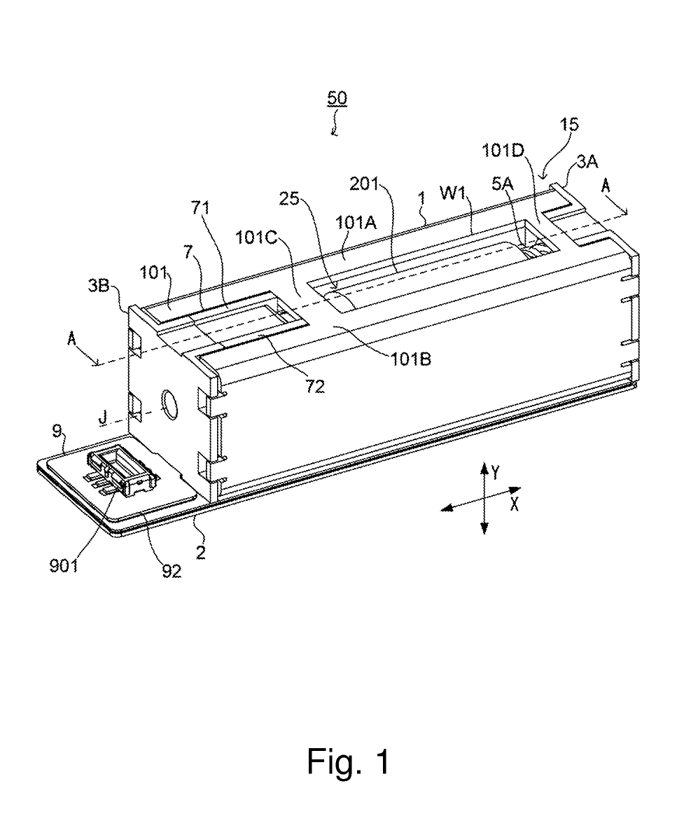

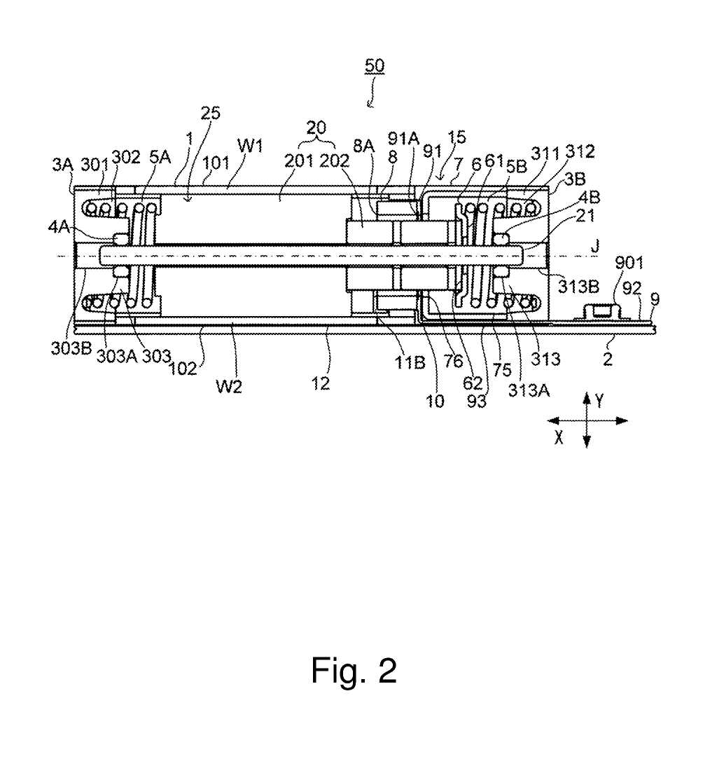

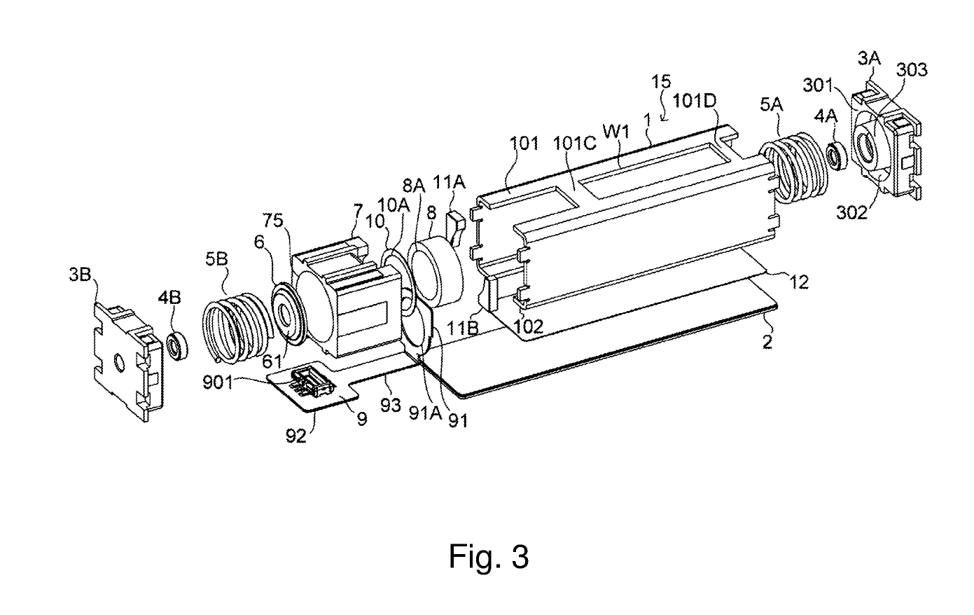

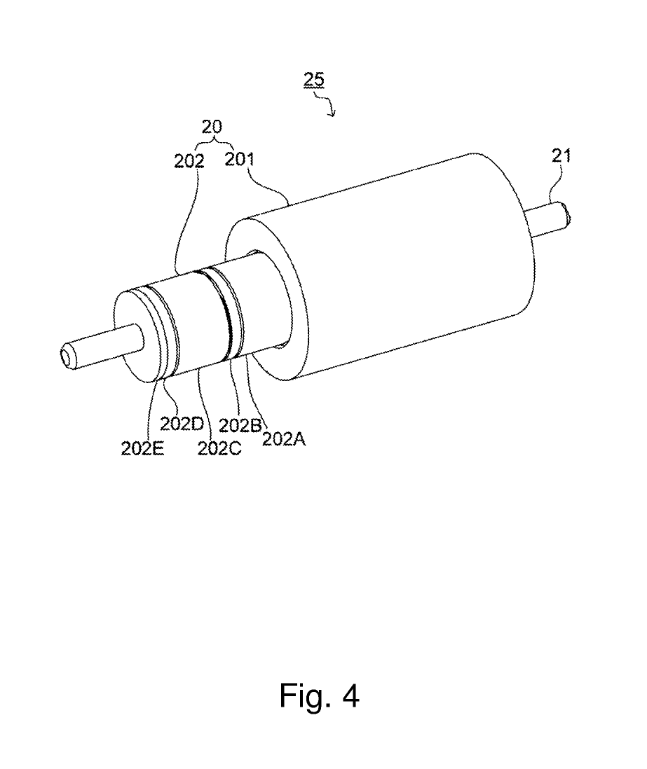

FIG. 1 is a general perspective view illustrating the external appearance of a vibration motor 50 according to an embodiment of the present invention. FIG. 2 is a side cross-sectional view taken along line II-II in FIG. 1. FIG. 3 is an exploded perspective view relating to the configuration other than a movable portion in the vibration motor 50. FIG. 4 is a perspective view illustrating the configuration of the movable portion in the vibration motor 50.

In the following description, a direction in which a center shaft J of a shaft 21 extends is referred to as “one direction,” and the one direction is illustrated as an X direction in FIGS. 1 and 2. Also, a Y direction orthogonal to the one direction in FIGS. 1 and 2 is referred to as “up-down direction.” A radial direction centered on the center axis J is merely referred to as “radial direction” and a circumferential direction centered on the center axis J is merely referred to as “circumferential direction.” The up-down direction, however, does not indicate the direction at actual assembly into a product.

The vibration motor 50 according to the embodiment of the present invention roughly includes a stationary portion 15, a movable portion 25, coil springs 5A and 5B, and a receiving plate 6. The movable portion 25 is supported movably in the one direction relative to the stationary portion 15, and vibrates in the one direction by using elastic force of the coil springs 5A and 5B.

### 2. Configuration of Stationary Portion

The stationary portion 15 includes a casing 1, a base plate 2, covers 3A and 3B, bearings 4A and 4B, a coil fixing portion 7, a coil 8, a flexible printed circuit (FPC) 9, an insulating tape 10, damper members 11A and 11B, and an insulating sheet 12.

### 2-1. Configuration Relating to Casing

The casing 1 has a cylindrical shape extending in the one direction and having a quadrangular ring-shaped cross section. Alternatively, the casing 1 may have a circular ring-shaped cross section. The casing 1 has a side surface 101 on the upper side in the up-down direction. The side surface 101 includes edge portions 101A and 101B arrayed in a direction orthogonal to the one direction and the up-down direction and extending in the one direction. The side surface 101 further includes bridge portions 101C and 101D that bridge the edge portions 101A and 101B. The bridge portions 101C and 101D are arrayed in the one direction. The side surface 101 further has a window portion W1, the four sides of the window portion W1 being surrounded by the edge portions 101A and 101B, and the bridge portions 101C and 101D.

The casing 1 further includes a side surface 102 (see FIG. 2) opposite to the side surface 101 in the up-down direction. The side surface 102 has a configuration similar to the configuration of the side surface 101 and hence has a window portion W2 similar to the window portion W1.

### 2-2. Configuration of Fixing Coil

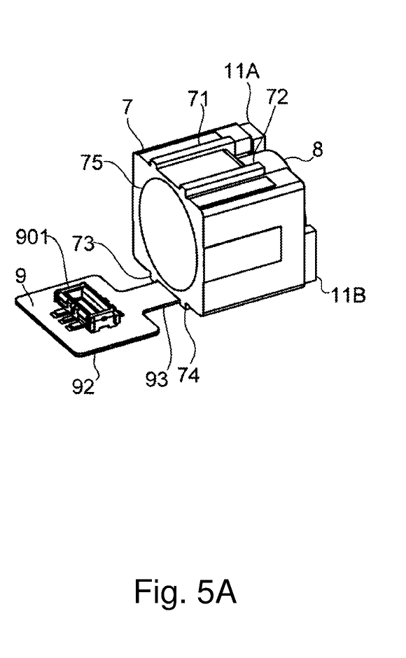

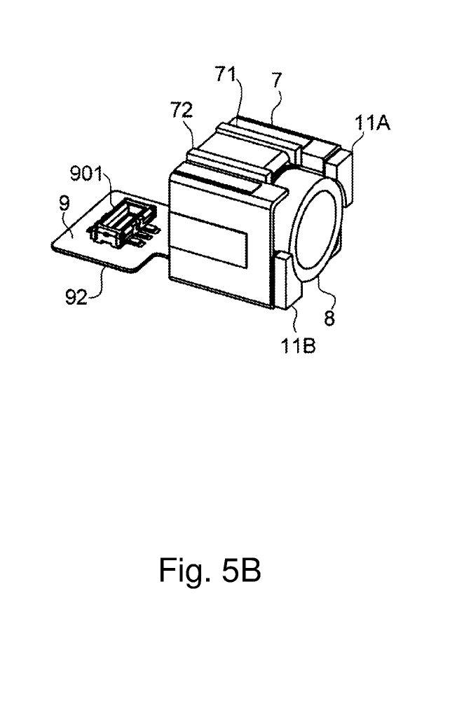

The coil 8 wound in the circumferential direction is fixed to the coil fixing portion 7. FIGS. 5A and 5B are perspective views each illustrating a state in which respective members including the coil 8 are fixed to the coil fixing portion 7. FIG. 5B is an illustration in a viewpoint different from the viewpoint of FIG. 5A.

The coil fixing portion 7 has a substantially rectangular-parallelepiped external appearance. An upper side surface of the coil fixing portion 7 has protruding pieces 71 and 72 arranged opposite to each other in a direction orthogonal to the one direction and the up-down direction, and extending in the one direction. A lower side surface of the coil fixing portion 7 has protruding pieces 73 and 74 arranged opposite to each other in the direction orthogonal to the one direction and the up-down direction, and extending in the one direction.

The coil fixing portion 7 has a hole portion 75 extending in the one direction and having an opening formed in one side surface in the one direction. The coil fixing portion 7 further has a through hole 76 (see FIG. 2) connected with the hole portion 75 in the one direction and having a smaller outer diameter than the outer diameter of the hole portion 75. The FPC 9 has a fixing portion 91. The fixing portion 91 is fixed to the surface, in which the through hole 76 is open and which is located on the side opposite to the hole portion 75 via the insulating tape 10.

The FPC 9 includes the fixing portion 91, a connector attachment portion 92, and a connection portion 93. A connector 901 is attached to the connector attachment portion 92. The connector 901 is attached, for example, by soldering. The connection portion 93 connects the fixing portion 91 with the connector attachment portion 92. The fixing portion 91 is arranged to bend in the up-down direction with respect to the connection portion 93 extending in the one direction. The fixing portion 91 is bonded to the insulating tape 10 and thus is fixed to the coil fixing portion 7 as described above. The connection portion 93 is arranged to extend in the one direction along a groove portion formed between the protruding pieces 73 and 74. The connector attachment portion 92 is arranged on the outside in the one direction with respect to the side surface in which the hole portion 75 of the coil fixing portion 7 is open.

The coil 8 is fixed to a surface of the fixing portion 91 opposite to a surface on the insulating tape 10 side. The coil 8 is electrically connected to the fixing portion 91, for example, by soldering. Accordingly, power can be applied to the coil 8 via the connector 901 and the FPC 9. Holes 10A, 91A, and 8A having the same diameter as the diameter of the through hole 76 are respectively formed in the insulating tape 10, the fixing portion 91, and the coil 8.

Also, the damper members 11A and 11B are fixed to an end portion of the coil fixing portion 7 to which the coil 8 is fixed. The damper members 11A and 11B are respectively arranged at two positions on a diagonal line of four corners of the end portion located around the coil 8 when the coil 8 is viewed in the one direction. The damper members 11A and 11B can contact an end surface of a weight 201.

### 2-3. Configuration Relating to Cover and Bearing

The cover 3A is arranged to close an end portion on the one side in the one direction of the casing 1. The cover 3A includes a base portion 301, a groove portion 302, and a bearing fixing portion 303. The bearing fixing portion 303 is arranged inside the base portion 301 in the radial direction via the groove portion 302 having a ring shape. The bearing fixing portion 303 protrudes toward the casing 1 in the one direction, and has a bearing fixing hole 303A on the casing 1 side. The bearing fixing portion 303 is connected with the bearing fixing hole 303A in the one direction, and has a through hole 303B having a smaller diameter than the diameter of the bearing fixing hole 303A. The bearing 4A is inserted into and fixed to the bearing fixing hole 303A.

The cover 3B is arranged to close an end portion on the other side in the one direction of the casing 1. That is, the cover 3B is opposite to the cover 3A in the one direction. The cover 3B includes a base portion 311, a groove portion 312, and a bearing fixing portion 313. The bearing fixing portion 313 is arranged inside the base portion 311 in the radial direction via the groove portion 312 having a ring shape. The bearing fixing portion 313 protrudes toward the casing 1 in the one direction, and has a bearing fixing hole 313A on the casing 1 side. The bearing fixing portion 313 is connected with the bearing fixing hole 313A in the one direction, and has a through hole 313B having a smaller diameter than the diameter of the bearing fixing hole 313A. The bearing 4B is inserted into and fixed to the bearing fixing hole 313A.

### 3. Configuration of Movable Portion

The movable portion 25 is housed in the casing 1, and includes a vibrating body 20 and a shaft 21. The vibrating body 20 is arranged outside the shaft 21 in the radial direction, and is fixed to the shaft 21. The vibrating body 20 includes the weight 201 and a magnet portion 202. The weight 201 is formed in a cylindrical shape extending in the one direction.

The magnet portion 202 is formed in a cylindrical shape extending in the one direction. The magnet portion 202 is arranged adjacently to the weight 201 in the one direction, and is arranged inside the coil 8 in the radial direction. As illustrated in FIG. 4, the magnet portion 202 includes a magnet 202A, a pole piece 202B, a magnet 202C, a pole piece 202D, and a spacer 202E sequentially arrayed from the weight 201 side in the one direction.

The shaft 21 is inserted through the inside of the weight 201 and the inside of the magnet portion 202, and thus penetrates through the vibrating body 20. Both end portions of the shaft 21 are supported by the bearings 4A and 4B movably in the one direction.

### 4. Configurations of Coil Springs and Receiving Plate

The coil spring 5A wound in the circumferential direction is arranged between the cover 3A and the weight 201. One side in the one direction of the coil spring 5A is housed in the groove portion 302 of the cover 3A. The other side in the one direction of the coil spring 5A contacts an end surface of the weight 201. The coil spring 5A overlaps the coil 8 in the one direction. The bearing 4A is arranged inside the coil spring 5A in the radial direction.

The coil spring 5B wound in the circumferential direction is arranged between the cover 3B and the magnet portion 202. One side in the one direction of the coil spring 5B is housed in the groove portion 312 of the cover 3B. The other side in the one direction of the coil spring 5B contacts the receiving plate 6. The coil spring 5B overlaps the coil 8 in the one direction.

The receiving plate 6 has a disk shape and includes a protruding portion 61 protruding toward the one side in the one direction. The protruding portion 61 is fitted to the inside of the coil spring 5B in the radial direction. An end surface of the magnet portion 202 contacts a recess 62 formed on the opposite side to the protruding side by the protruding portion 61. Also, the bearing 4B is arranged inside the coil spring 5B in the radial direction.

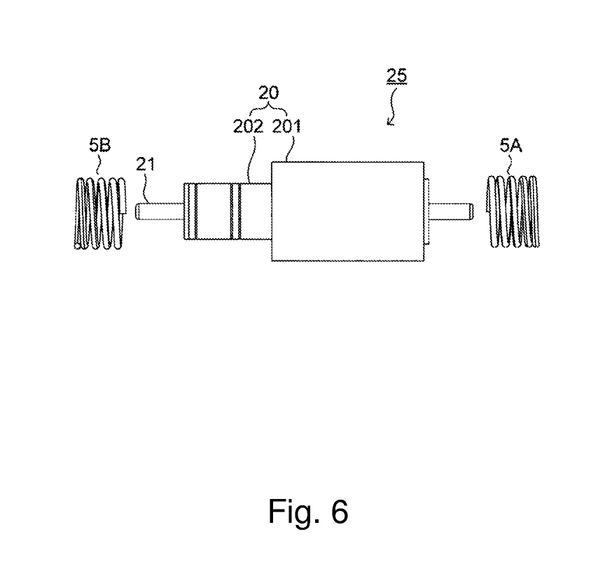

FIG. 6 is a side view illustrating the arrangement relationship of the respective coil springs 5A and 5B with respect to the movable portion 25 in the exploded state. As illustrated in FIG. 6, the coil springs 5A and 5B are wound so as to advance toward each other in the one direction as the coil springs 5A and 5B are rotated rightward (toward the same side) in the circumferential direction when the coil springs 5A and 5B are viewed from mutually opposite sides in the one direction.

### 5. Method of Assembling Vibration Motor

A method of assembling the vibration motor 50 formed of the respective portions having the above-described configurations is described.

The movable portion 25 is assembled by fixing the weight 201 and the magnet portion 202 to the shaft 21 in advance in a different step. This fixture is performed, for example, by bonding with an adhesive.

Also, the configuration in which the insulating tape 10, the FPC 9, the coil 8, and the damper members 11A and 11B are fixed to the coil fixing portion 7 as described above (FIG. 5A, FIG. 5B) is inserted into the casing 1 from the end portion on the one side in the one direction of the casing 1 and is fixed to the casing 1. At this time, the protruding pieces 71 and 72 of the coil fixing portion 7 contact the bridge portion 101C of the casing 1 (FIG. 1), and the protruding pieces 73 and 74 contact the bridge portion located below the bridge portion 101C of the casing 1. Hence the coil fixing portion 7 is positioned in the one direction.

Then, the bearing 4B is fixed to the cover 3B, one end of the coil spring 5B is housed in the cover 3B, and the receiving plate 6 is fitted to the other end of the coil spring 5B. In this state, the cover 3B is fixed to the one end of the casing 1. In this state, the coil spring 5B and the receiving plate 6 are housed in the hole portion 75 of the coil fixing portion 7.

Then, the magnet portion 202 side of the movable portion 25 is inserted into the casing 1 from an end portion of the casing 1 on the side opposite to the side to which the cover 3B is fixed. By inserting the movable portion 25, one end portion of the shaft 21 is supported by the bearing 4B. Also, the magnet portion 202 is arranged inside the hole portion 75, the through hole 76, and the holes 10A, 91A, and 8A in the radial direction. The spacer 202E included in the magnet portion 202 contacts the receiving plate 6. Alternatively, the magnet may directly contact the receiving plate. That is, the magnet may directly or indirectly contact the receiving plate 6.

Then, the bearing 4A is fixed to the cover 3A, and one end of the coil spring 5A is housed in the cover 3A. In this state, the cover 3A is fixed to the one end of the casing 1. Accordingly, the one end of the coil spring 5A contacts the end surface of the weight 201. Also, the one end portion of the shaft 21 is supported by the bearing 4A.

Also, the insulating sheet 12 is arranged below the casing 1, and extends in the one direction. Further, the base plate 2 is arranged below the insulating sheet 12, and extends in the one direction. One end portion of the base plate 2 is arranged to protrude toward the cover 3B in the one direction with respect to the casing 1. The connector attachment portion 92 of the FPC 9 is arranged on the base plate 2. Also, the connection portion 93 of the FPC 9 is arranged on the insulating sheet 12 to provide insulation with respect to the base plate 2.

The vibration motor 50 is assembled by the above-described method. Since the vibration motor 50 is assembled after the movable portion 25 is assembled in advance, the assembly can be easily performed.

In the assembled vibration motor 50, both end portions of the shaft 21 are respectively supported by the bearings 4A and 4B movably in the one direction. Also, the receiving plate 6 is constantly pressed to the end surface of the magnet portion 202 by the elastic force of the coil spring 5B. Also, the one end of the coil spring 5A is constantly pressed to the end surface of the weight 201 by the elastic force. By controlling current flowing to the coil 8, the movable portion 25 vibrates in the one direction relative to the stationary portion 15.

### 6. Exemplarily Configuration and Advantageous Effect Realized by Present Embodiment

As described above, a vibration motor 50 according to this embodiment includes:

a shaft 21 having a center axis J extending in one direction;

a stationary portion 15 having a coil 8 wound in a circumferential direction of the center axis J;

a vibrating body 20 arranged outside the shaft 21 in a radial direction and being vibratable in the one direction relative to the stationary portion 15; and

coil springs 5A and 5B arranged between the stationary portion 15 and the vibrating body 20, and wound in the circumferential direction.

The vibrating body 20 includes a weight 201 and magnets 202A and 202C arranged inside the coil 8 in the radial direction.

The coil springs 5A and 5B overlap the coil 8 in the one direction

With this configuration, the diameter of the coil springs 5A and 5B can be increased. When the vibrating body 20 vibrates, generation of buckling at the coil springs 5A and 5B can be suppressed.

Also, the vibration motor 50 further includes: a receiving plate 6 arranged between the magnets 202A and 202C and the coil spring 5B so that the magnets 202A and 202C directly or indirectly contact the receiving plate 6 in the one direction. The receiving plate 6 includes a protruding portion 61 protruding in the one direction and housed inside the coil spring 5B in the radial direction.

With this configuration, the receiving plate 6 can be easily positioned with respect to the coil spring 5B.

Also, the stationary portion 15 further includes bearings 4A and 4B that contact the shaft 21 fixed to the vibrating body 20.

The bearings 4A and 4B are arranged inside the coil springs 5A and 5B in the radial direction.

With this configuration, the bearings 4A and 4B do not have to be arranged in a manner shifted in the one direction with respect to the coil springs 5A and 5B, and hence the total length of the vibration motor 50 in the one direction can be decreased.

The stationary portion 15 further includes a coil fixing portion 7 to which the coil 8 is fixed. Damper members 11A and 11B are provided at an end portion of the coil fixing portion 7 to which the coil 8 is fixed so that the weight 201 contacts the damper members 11A and 11B.

With this configuration, the weight 201 contacts the damper members 11A and 11B, for example, when the vibration motor 50 is dropped. Hence breakage of the coil 8 which may occur when the weight 201 collides with the coil 8 can be suppressed.

The damper members 11A and 11B are arranged at two positions of four corners of the end portion located around the coil 8 when the coil 8 is viewed in the one direction. A damper member may be arranged at at least one of the four corners.

With this configuration, the four corners, which may be dead spaces with wide areas, can be effectively used.

The two damper members 11A and 11B are arranged on a diagonal line. With this configuration, the impact to the weight 201 caused by collision can be absorbed in a well balanced manner while the number of components of the damper members is decreased.

The two coil springs 5A and 5B are arranged at both ends of the vibrating body 20 in the one direction, and the coil springs 5A and 5B are wound so as to advance toward each other in the one direction as the coil springs 5A and 5B are rotated toward a same side in the circumferential direction when the coil springs 5A and 5B are viewed from mutually opposite sides in the one direction.

With this configuration, even when one of the coil springs 5A and 5B applies a stress in the circumferential direction to the vibrating body 20, the other coil spring resists the stress, or a stress by the other coil spring is applied to the vibrating body 20 in the opposite direction. Accordingly, the stresses are canceled with each other, and hence generation of a noise due to a twist generated at the vibrating body 20 can be suppressed.

### 7. Modifications

Modifications of the aforementioned embodiment are described below.

A damper member may be fixed to the cover 3A so that the weight 201 can contact the damper member. For example, a ring-shaped damper member may be fixed to an end surface of the bearing fixing portion 303 of the cover 3A on the inside of the coil spring 5A in the radial direction, or a ring-shaped damper member may be fixed to an end surface of the base portion 301 on the outside of the coil spring 5A in the radial direction.

That is, the stationary portion 15 may include the cover 3A that houses the coil spring 5A, and the cover 3A may be provided with a damper member so that the weight 201 contacts the damper member. With this configuration, generation of a noise, which may be generated when the weight 201 contacts the cover 3A, can be suppressed.

In the aforementioned embodiment, the outer diameter of the weight 201 is substantially equivalent to the distance between the window portion W1 and the window portion W2 of the casing 1. That is, the weight 201 is not arranged in the window portions W1 and W2. Accordingly, the weight 201 can be inserted into the casing 1 at assembly.

If the casing 1 is formed of parts divided in the up-down direction, the outer diameter of the weight 201 may be slightly increased and a portion of the weight 201 may be arranged in the window portions W1 and W2.

That is, the stationary portion 15 may include the casing 1 that houses the weight 201, and the casing 1 may have side surfaces having the window portions W1 and W2 extending in the one direction in which portions of the weight 201 is arranged.

With this configuration, the weight of the weight 201 can be increased as much as possible, and the inertial force can be increased.

At this time, the lengths of the window portions W1 and W2 in the one direction each are larger than the length of the weight 201 in the one direction. Accordingly, when the movable portion 25 vibrates, a region where the weight 201 moves in the one direction can be ensured.

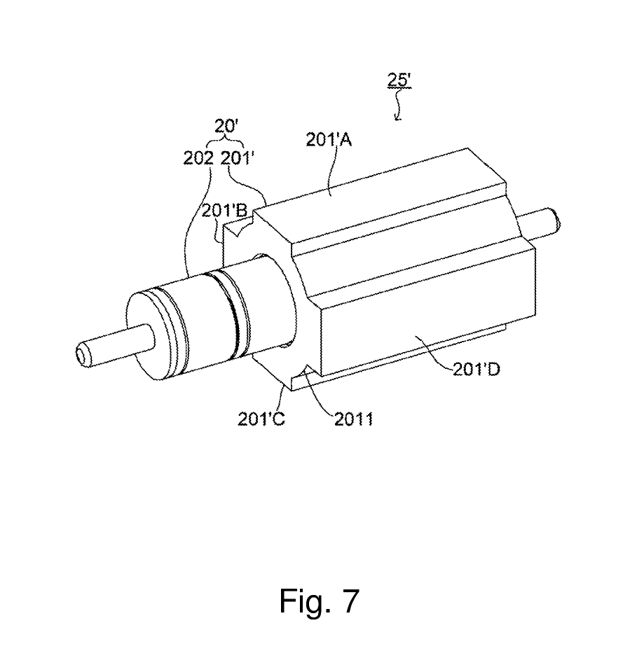

FIG. 7 is a perspective view illustrating the configuration of a movable portion 25′ according to a modification. The movable portion 25′ illustrated in FIG. 7 includes a vibrating body 20′ and a shaft 21. The vibrating body 20′ includes a weight 201′ and a magnet portion 202. The weight 201′ includes protruding portions 201′A to 201′D protruding toward four sides in the radial direction from a cylindrical base column 2011.

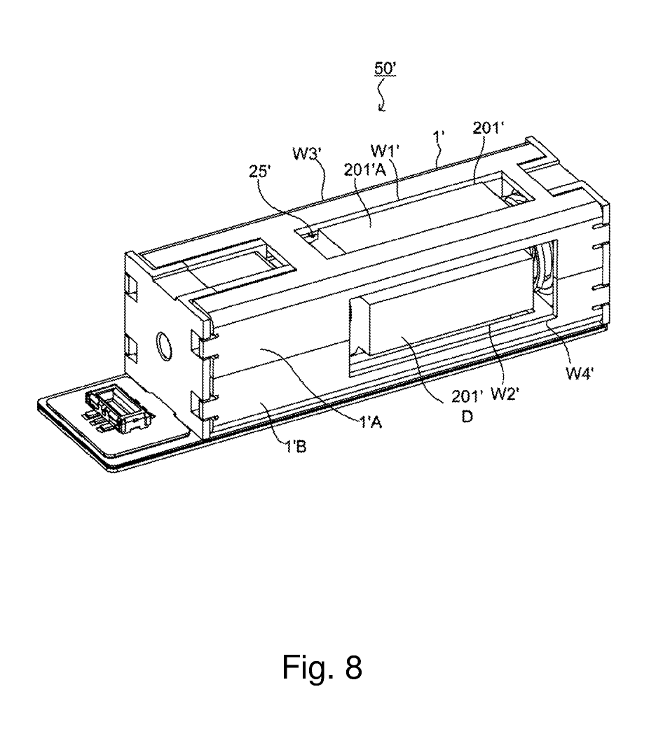

FIG. 8 is a perspective view illustrating the external appearance of a vibration motor 50′ according to the modification including the movable portion 25′ illustrated in FIG. 7. As illustrated in FIG. 8, the vibration motor 50′ includes a casing 1′ having window portions W1′ to W4′ at upper and lower side surfaces and side surfaces opposite to each other in a direction orthogonal to the up-down direction.

The protruding portion 201′A is arranged in the window portion W1′. The protruding portion 201′B is arranged in the window portion W3′. The protruding portion 201′C is arranged in the window portion W2′. The protruding portion 201′D is arranged in the window portion W4′.

With this configuration, the weight of the weight 201′ can be increased as much as possible. In such a modification, the casing 1′ is formed of an upper casing part 1′A and a lower casing part 1′B which are vertically divided, as an example of parts that can be assembled.

### 8. Other Modifications

While the embodiment of the present invention has been described above, the embodiment can be modified in various ways within the scope of the present invention.

For example, the coil springs do not have to be provided on both sides in the one direction of the vibrating body, and a coil spring may be provided only on one side in the one direction. In other words, the number of coil springs may be one.

The shaft does not have to penetrate through the vibrating body. For example, two shafts may be provided, one of the shafts may be inserted into the vibrating body up to an intermediate position from the end surface side of the weight, and the other shaft may be inserted into the vibrating body up to an intermediate position from the end surface side of the magnet portion.

Alternatively, a shaft may be fixed to covers on both sides in the one direction, and a vibrating body formed of a weight and a magnet portion may be movable relative to the shaft. In this case, no bearing is required.

The present invention can be used for a vibration motor included in, for example, a smartphone or a gamepad.

Features of the above-described preferred embodiments and the modifications thereof may be combined appropriately as long as no conflict arises.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A vibration motor, comprising:
a shaft having a center axis extending in one direction;
a stationary portion having a coil wound in a circumferential direction of the center axis;
a vibrating body arranged outside the shaft in a radial direction and being vibratable in the one direction relative to the stationary portion; and
at least a single coil spring arranged between the stationary portion and the vibrating body, and wound in the circumferential direction,
wherein the vibrating body includes
a weight, and
a magnet arranged inside the coil in the radial direction, in the one direction with respect to the weight, and
wherein the coil spring overlaps the coil in the one direction.

2. The vibration motor according to claim 1, further comprising:
a receiving plate arranged between the magnet and the coil spring so that the magnet directly or indirectly contacts the receiving plate in the one direction,
wherein the receiving plate includes a protruding portion protruding in the one direction and housed inside the coil spring in the radial direction.

3. The vibration motor according to claim 2,
wherein the stationary portion further includes a bearing that contacts the shaft fixed to the vibrating body, and
wherein the bearing is arranged inside the coil spring in the radial direction.

4. The vibration motor according to claim 3,
wherein the stationary portion further includes a coil fixing portion to which the coil is fixed, and
wherein at least a single damper member is provided at an end portion of the coil fixing portion to which the coil is fixed so that the weight contacts the damper member.

5. The vibration motor according to claim 4, wherein the damper member is arranged at at least one of four corners of the end portion located around the coil when the coil is viewed in the one direction.

6. The vibration motor according to claim 5, wherein the damper member includes two damper members arranged on a diagonal line.

7. The vibration motor according to claim 6, wherein the stationary portion further includes a casing that houses the weight, the casing having a side surface provided with at least a single window portion extending in the one direction so that a portion of the weight is arranged in the window portion.

8. The vibration motor according to claim 7, wherein the window portion has a larger length in the one direction than a length of the weight in the one direction.

9. The vibration motor according to claim 8, wherein the coil spring includes two coil springs, the coil springs being arranged at both ends of the vibrating body in the one direction, the coil springs being wound so as to advance toward each other in the one direction as the coil springs are rotated toward a same side in the circumferential direction when the coil springs are viewed from mutually opposite sides in the one direction.

10. The vibration motor according to claim 3, wherein the stationary portion further includes a cover that houses the coil spring, the cover being provided with a damper member so that the weight contacts the damper member.

11. The vibration motor according to claim 10, wherein the stationary portion further includes a casing that houses the weight, the casing having a side surface provided with at least a single window portion extending in the one direction so that a portion of the weight is arranged in the window portion.

12. The vibration motor according to claim 11, wherein the window portion has a larger length in the one direction than a length of the weight in the one direction.

13. The vibration motor according to claim 12, wherein the coil spring includes two coil springs, the coil springs being arranged at both ends of the vibrating body in the one direction, the coil springs being wound so as to advance toward each other in the one direction as the coil springs are rotated toward a same side in the circumferential direction when the coil springs are viewed from mutually opposite sides in the one direction.
